(19) United States
(12) Patent Application Publication
(10) Pub. No.: US 2021/0224697 A1
(43) Pub. Date: Jul. 22, 2021

(54) SYSTEMS, METHODS, AND STORAGE MEDIA FOR DECREASING BUSINESS-TO-CONSUMER WAIT TIMES

(71) Applicant: aBitNow Inc., Wilmington, DE (US)

(72) Inventors: Daniel Lester Stolts, II, Lakeville, MA (US); Aaron Leeland Silkwood, Castlerock, CO (US)

(21) Appl. No.: 16/747,052

(22) Filed: Jan. 20, 2020

(51) Int. Cl. G06Q 10/02; G06Q 50/12; G06Q 30/02; G06Q 20/10

(52) U.S. Cl. CPC G06Q 10/02; G06Q 50/12; G06Q 30/0224; G06Q 20/10; G06Q 30/0226

(57) ABSTRACT

Systems, methods, and storage media for decreasing business-to-consumer wait times are disclosed. Exemplary implementations may: locate an entity using one or more filters, including price, rating, or distance; select at least one of the one or more entity offerings; identify an entity visit time; send a request from a user to the entity; receive an acceptance from the entity to the user; send one or more updates of the entity visit time from the user to the entity; send one or more updates for a status of the entity offerings from the entity to the user; and provide at least a portion the one or more entity offerings at the specified location at or near the entity visit time.

### FIELD OF THE DISCLOSURE

The present disclosure relates to systems, methods, and storage media for decreasing business-to-consumer wait times.

### BACKGROUND

Business-to-consumer commerce (e.g., restaurants) often involves significant wait times for customers and restaurant staff alike. For instance, customers visiting a dine-in establishment may endure significant wait times while waiting for a table, waiting for their orders to be taken, waiting for beverages, waiting for food, waiting for their check and subsequent payment to process, etc. Further, servers and other restaurant staff may also need to deal with customer indecision time, time to process payment, etc. Existing technologies for business-to-consumer commerce, especially in the dine-in restaurant industry, suffer from inefficiencies, which are wasteful to the business in terms of adequate use of resources and time. In addition, customers also waste a significant amount of time while visiting restaurants, which reduces their desire to visit the same. In such cases, the bottom line (i.e., profit) for the business may suffer.

Current technologies related to business-to-consumer wait times include digital dine-in restaurant table reservation applications such as, but not limited to the OpenTable application provided by OpenTable, Inc. located at 1 Montgomery St. Ste 700, San Francisco, Calif. 94104, mobile ordering applications such as, but not limited to, the Mobile Order Takers application provided by Revel Systems, Inc. located at 575 Market Street, Suite 2200, San Francisco, Calif. 94105, and table-located digital ordering devices (aka kiosks). However, the underlying operation of these technologies fails to address the greatest factor affecting consumer wait times—waiting for the initial service to be provided by the business.

### SUMMARY

In order to address the deficiencies in the current technology, disclosed herein is a system and a method for optimizing wait states, as well as providing timely status updates, feedback, and incentives to both businesses and users alike to enhance user experience. It should be noted that the terms user, customer, or consumer may be used interchangeably throughout this application. Further, the terms restaurant, establishment, dine-in establishment, dine-in restaurant, or entity may also be used interchangeably throughout this application and may be applied to similar systems outside of the restaurant industry.

The present disclosure is generally directed to reducing or eliminating wait times for customers, which may serve to increase customer satisfaction and provide greater customer turnover, leading to increased sales for the business implementing the systems described herein. As described above, current processes in business-to-consumer (B2C) commerce, especially restaurants, are lengthy and inefficient. Customers endure significant wait times for multiple, if not all, steps in the process. By providing new technology that eliminates or otherwise, decreases wait states for both customers and businesses, businesses may not only be able to improve customer experience, but also serve more patrons, which may serve to increase their revenue and profit as it is contemplated that such new technology will comprise a minimal increase in cost. In some examples, cost may be associated with installing the system, using the system, service or training, and/or advertisements placed within the system.

Current technologies for enhancing customer experience and reducing wait times in service-providing industries have relied on adding capabilities (e.g., delivery, order online, etc.), but have shied away from the perspective of saving time for the restaurant and the customer. In other words, minimal effort has been directed towards optimizing customer dine-in experience. The present disclosure serves to alleviate these problems by providing a streamlined process for reserving tables by providing a Just in Time (JiT) table option and the underlying technology supporting use of these tables. It is contemplated that the technology may be utilized separate from the JiT tables with regular table reservation systems. Regular tables may comprise a first table type and Just in Time tables may comprise a second table type. These JIT tables comprise tables available to serve customers at time slots identified by a customer's anticipated arrival time via the technology as described herein. In some cases, such a customer may request the restaurant provide the customer with one of these tables, also referred to herein as a “spot”. For example, the new technology may further include a full order for all persons accessing the table. The restaurant may accept such an order for the table with the acceptance comprising a mutual agreement between the business and the customer to have one or more items identified in the order ready at an arrival time, with the customer agreeing to be at the restaurant at the arrival time.

To effectuate the implementation of the new technology, both business and the customer may receive real-time updates (e.g., an estimated time of arrival (“ETA”) for one or more of the persons accessing the table, based on GPS coordinates, the status of the items in the order such as, but not limited to, a menu item is on the grill, drinks are ready, etc.) which may allow participants to plan and respond accordingly. For example, the system may alert the business that the customer is has a new ETA. In such an instance the business may plan and respond by delaying or fast-tracking the order so that one or more of the order items are at the proper temperature and available at the customer's table when the customer arrives. In some examples, the system may also include provisions for the customer or the business to provide a revised ETA due to unforeseen delays or incidental issues, if any. Thus, the systems, methods, and storage media of the present disclosure may serve to provide a mechanism for constant innovation and improvement of the processes.

One system configured for decreasing business-to-consumer wait times may comprise one or more hardware processors configured by machine-readable instructions. The processor(s) may be configured to locate an entity. One such entity may offer decreased wait times as described herein to receive one or more entity offerings at a specified location. The processor(s) may be configured to select at least one of the one or more entity offerings, identify an entity visit time, and send a request from a user to the entity. One such request may be to receive the one or more entity offerings at the specified location for the entity visit time. The processor(s) may be further configured to receive an acceptance from the entity to the user and the acceptance may comprise an agreement to provide the one or more entity offerings to the customer at the entity visit time. The processor(s) may yet be further configured to send one or more updates of the entity visit time from the user to the entity, send one or more updates for a status of the entity offerings from the entity to the user, and provide at least a portion of the one or more entity offerings at the specified location at or near the entity visit time.

Another aspect of the present disclosure relates to a method for decreasing business-to-consumer wait times. The method may include locating an entity. The entity may offer decreased wait times to receive one or more entity offerings at a specified location. The method may include selecting at least one of the one or more entity offerings. The method may include identifying an entity visit time. The method may include sending a request from a user to the entity. The request may include a request to receive the one or more entity offerings at the specified location for the entity visit time. The method may include receiving an acceptance from the entity to the user. The acceptance may include agreeing to provide the one or more entity offerings at the entity visit time. The method may include sending one or more updates of the entity visit time from the user to the entity. The method may include sending one or more updates for a status of the entity offerings from the entity to the user. The method may include providing at least a portion of the one or more entity offerings at the specified location at or near the entity visit time.

Yet another aspect of the present disclosure relates to a non-transient computer-readable storage medium having instructions embodied thereon, the instructions being executable by one or more processors to perform a method for decreasing business-to-consumer wait times. The method may include locating an entity. The entity may offer decreased or zero wait times to receive one or more entity offerings at a specified location. The method may include selecting at least one of the one or more entity offerings. The method may include identifying an entity visit time. The method may include sending a request from a user to the entity. The request may include a request to receive the one or more entity offerings at the specified location for the entity visit time. The method may include receiving an acceptance from the entity to the user. The acceptance may include agreeing to provide the one or more entity offerings at the entity visit time. The method may include sending one or more updates of the entity visit time from the user to the entity. The method may include sending one or more updates for a status of the entity offerings from the entity to the user. The method may include providing at least a portion of the one or more entity offerings at the specified location at or near the entity visit time.

These and other features and characteristics of the technology as well as the methods of operation and functions of the related elements, structure and combination of the parts and economies of manufacture will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured for decreasing business-to-consumer wait times, in accordance with one or more implementations.

FIG. 2 illustrates a method for decreasing business-to-consumer wait times, in accordance with one or more implementations.

FIG. 3 illustrates a communication system for decreasing business-to-consumer wait times, in accordance with one or more implementations.

FIG. 4A illustrates a visualization of a screen for a customer searching an entity according to various embodiments of the disclosure.

FIG. 4B illustrates a visualization of a screen for a customer selecting an entity according to various embodiments of the disclosure.

FIG. 5 illustrates a visualization of a screen for a customer placing an order with the entity according to various embodiments of the disclosure.

FIG. 6 illustrates a visualization of a screen for a customer receiving a confirmation of the order and tracking status of the order according to various embodiments of the disclosure.

FIG. 7 illustrates a visualization of a screen for a customer providing real-time feedback for the business according to various embodiments of the disclosure.

FIG. 8 illustrates a visualization of a screen for a customer providing feedback for an application linked to the system according to various embodiments of the disclosure.

FIG. 9 is a block diagram illustrating a computer system according to various embodiments of the disclosure.

### DETAILED DESCRIPTION

The words “for example” is used herein to mean “serving as an example, instant, or illustration.” Any embodiment described herein as “for example” or any related term is not necessarily to be construed as preferred or advantageous over other embodiments. Additionally, a reference to a “device” is not meant to be limiting to a single such device. It is contemplated that numerous devices may comprise a single “device” as described herein.

Current processes in business-to-consumer (B2C) businesses include one or more wait states for business and consumers alike. In some cases, these wait states lead to wasted time, resulting not only in loss of revenue and profits for the business, but also loss of time for the consumer.

As described above, customers visiting a dine-in establishment may endure significant wait times while waiting for a table, waiting for their orders to be taken, waiting for beverages, waiting for food, waiting for their check and subsequent payment to process, etc. Further, servers and other restaurant staff may also need to deal with customer indecision time, time to process payment, etc. Besides loss of revenue and profits due to wait states, there is also significant waste of reusable and consumable products (i.e., food) in the restaurant industry. In one example, a burger joint may see a large amount of lettuce, tomatoes, and/or onions being wasted by their customers, which may be entirely prevented by not putting them on in the first place.

The Applicant's disclosure aims to alleviate some of these shortcomings of the current B2C experience through a digital transformation encompassing an end to end solution designed to meet both consumer and business needs. Specifically, the Just in Time (JiT) system allows for integration of consumer demand and business availability (i.e., for both products and services), and enhances a businesses' ability to forecast consumer demand. In some aspects, the consumer or customer may gain a “JiT” consumption of goods (or services) to meet their needs.

In some cases, the system may comprise a wide range of search (e.g., keyword search, industry specific search fields, combination of many search or filter capabilities) and location or geotracking capabilities (e.g., location/proximity to consumer). As a non-limiting example of an industry specific search field, the customer could search for a business with table availability and no wait, or the same with a rating of 4.5 or higher. Location or geotracking may also facilitate shared Estimated Time of Arrival (ETA) between consumer and businesses. The location may be provided manually or automatically (e.g., via consumer GPS or location enabled devices, including smartphones, tablets, laptops, etc.) by the consumer. In some cases, the system may include an integrated business merchant system, including one or more of menu and product management, a Point of Sale (POS) system, computing devices (e.g., tablets, printers, etc.), training (e.g., in person, online, and on demand), as well as marketing, advertising, and other tools and resources.

In some examples, the system may also include an integrated product, payment, and feedback system. For instance, the system may allow consumers the ability to save, tag, or mark business products or services as “favorites”. Further, the system may comprise an end-to-end feedback system, which may be fully and timely integrated with the product and subsequent payment. In some circumstances, such timely feedback integration may reduce the lag experienced from requesting feedback through traditional means (e.g., please review our restaurant or business on YELP, TRIPADVISOR, etc., or follow this link on your receipt to give us your feedback) or even “offline” manners, which may be often overlooked or forgotten. Further, the timely feedback integration may also serve to enhance the quality and accuracy of feedback received, since the feedback is immediate and tied to the engagement or occurrence.

In some cases, the system may also support an integrated reward program for both customers and business entities. For instance, customers and restaurants may earn “badges” or “points” based on their interaction with the JiT system. In some cases, these “badges” or “points” may be used for a variety of incentives, including freebies and discounts, for current or future engagement. In other cases, the application or system may also incorporate games (e.g., Table Spin Game) and users may receive free spins for utilization of the application. Such spins may be paired with discount offers, reward points, free stuff, etc.

In some cases, engagement and awareness of the system may be supported via social media and targeted marketing, based on which customers may be able to receive coupons, discounts, savings, or even social media rewards and programs.

Besides enhancing the customer experience, business entities may also see enhancements not seen in current techniques. For example, menu and product management, table administration management (e.g., available tables, JiT table designations, table size and configuration, etc.), and search options (e.g., menu, cuisine, JiT table availability, etc.) may be optimized via the JiT system described herein. It is contemplated that JiT tables may comprise tables available for reservation only through a JiT system or may be available for reservation via non-JiT system as well. Such tables may be located in a specific area within the restaurant—for example, near a restaurant entrance/exit and/or near an access to the restaurant kitchen. A JiT table reservation may include a user agreement to use the one or more features associated with the disclosure herein while accessing the JiT table. Such an agreement may include a statement time limit. For example, if a user accesses a JiT table after the time limit (e.g. 25 minutes), the user may agree to an increased fee. Other time limits are contemplated. In some embodiments, the JiT system or application may provide business entities, such as restaurants or bars, with a self-service portal. This portal may be cloud based or web-based, or even a mobile app. In some cases, the mobile app used by businesses may be different from the app used by users or customers. The self-service portal may enable restaurants to manage their data and configurations. For instances, restaurants or entities may use the portal to manage all their entity offerings (i.e., products), staff, ingredients, reports, to name a few non-limiting examples. By relieving entities of some of the time and effort that goes into managing the same, business owners or managers may be able to focus on other aspects of their business. In some cases, the self-service portal may be available on a subscription basis, to name one example.

In some cases, business entities may allow their customers to fully customize their orders using the JiT system. For instance, the system may allow customers the ability to view the ingredients in each dish or entity offering and customize the dish based on allergies, calories, preparation time, or any other preference. In some examples, the complete list of ingredients for an entity offering may be shown along with a calorie count for each ingredient. Additionally or alternatively, a complete calorie count may be shown for the entire meal. In some aspects, allowing a customer to fully customize their order may not only reduce food wastage, but also improve customer satisfaction. In some examples, the system may also list a cook time or preparation time for each item on the menu (i.e., entity offering) for the customer and/or staff members. Besides allowing customers to have an idea of how long their entity offering or meal would take, cooks or staff members may also receive notifications or alerts regarding the meal (e.g., when to start different components of the menu item, when to take off the grill, etc.). In some cases, the JiT system may also support Professional Services Automation (PSA) integration. For instance, the JiT system may comprise a JiT Optimization Platform, where the optimization platform integrates through both Application Programming Interface (API) calls from the PSA and/or API calls to the JiT platform. Such an integration may allow for auto updating sales, inventory and other components needed for many PSA systems. In some cases, data that comes through the JiT Optimization Platform could be included or added to the standard or previously customized reports in these systems. As an example, a nightly shift report that shows income by server may include data directly received by the JiT platform without servers or other staff needing to re-type any data. Thus, in some aspects, the PSA integration may serve to enhance experience for business entities.

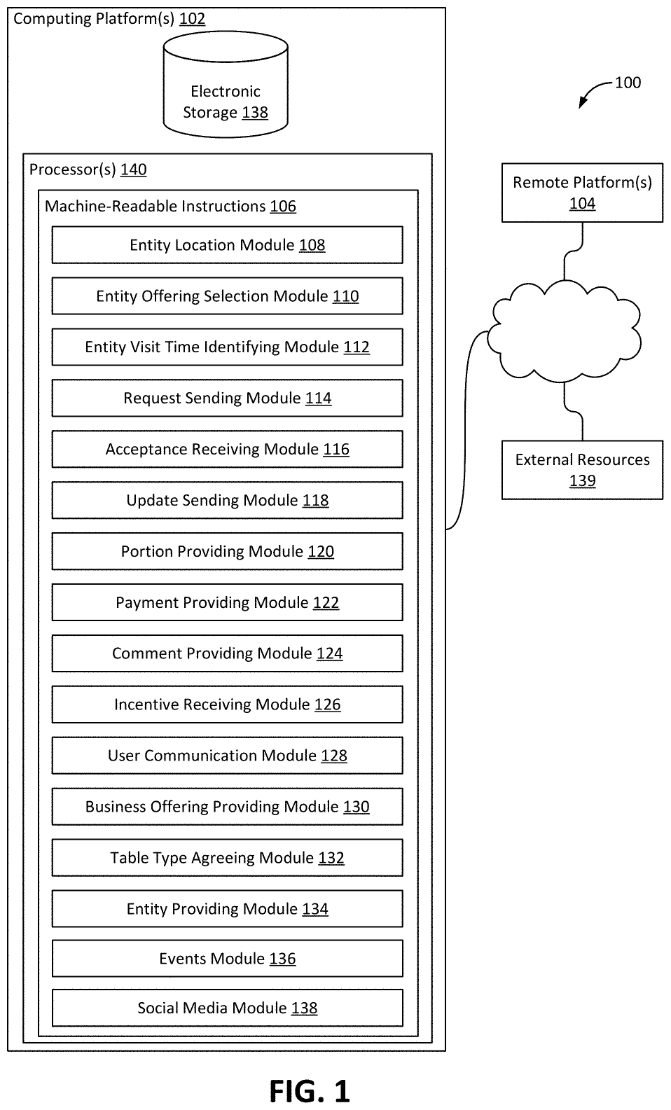

Aspects of the disclosure are initially described in the context of a system for decreasing business-to-consumer wait times. The described techniques relate to improved methods, systems, processes, computing platforms and storage media that support decreased B2C wait times, further described in relation to FIGS. 1-9.

FIG. 1 illustrates a system 100 configured for decreasing business-to-consumer wait times, in accordance with one or more implementations. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Machine-readable instructions 106 may include one or more instruction modules. The instruction modules may include computer program modules. The instruction modules may include one or more of entity location module 108, entity offering selection module 110, entity visit time identifying module 112, request sending module 114, acceptance receiving module 116, update sending module 118, portion providing module 120, payment providing module 122, comment providing module 124, incentive receiving module 126, user communication module 128, business offering providing module 130, table type agreeing module 132, entity providing module 134, and/or other instruction modules.

Entity location module 108 may be configured to locate an entity. The entity may offer decreased wait times to receive one or more entity offerings at a specified location. The one or more entity offerings may include menu options.

Entity location module 108 may be configured to locate an entity based on at least one of a keyword search and an industry-specific search. The entity may include a restaurant. By way of non-limiting example, sending one or more updates for a status of the entity offerings from the entity to the user may include sending at least one of a table reserved notification, a menu item on the table notification, a menu item being prepared notification, and a menu item ready in an identified time notification. Providing payment to the entity via a pre-paid account may include enabling a direct payment to the identified restaurant staff member or group and identifies cost associated with each menu option associated with the user and the one or more additional users.

Entity offering selection module 110 may be configured to select at least one of the one or more entity offerings. In some examples, the one or more entity offerings may be customizable by a user prior to selection. For instance, the user may be able to view a list of ingredients for the one or more entity offerings and remove any ingredient based on personal preference, allergies, calories, preparation time, etc. The user may also add or substitute ingredients while selecting at least one of the one or more entity offerings. In some cases, the entity offering selection module 110 may be configured to identify if the entity is out of stock of a particular ingredient (e.g., onions), and flag all entity offerings that include that ingredient. In such cases, the user may be made aware of the missing ingredient and may choose from the one or more entity offerings accordingly.

Entity visit time identifying module 112 may be configured to identify an entity visit time. The entity visit time may include a dining reservation time. The entity visit time may include an original entity visit time.

Request sending module 114 may be configured to send a request from a user to the entity. By way of non-limiting example, locating an entity may include at least one of finding an entity in a specified area and finding an entity in a proximity to the user. By way of non-limiting example, providing one or more comments from the user to the entity may include at least one of contacting an identified restaurant staff member or group, updating the one or more entity offerings, a table reserved rating, a menu item on the table rating, a menu item being prepared rating, and a menu item ready in an identified time rating. The request may further include requesting a first table type. Sending one or more updates of the entity visit time from the user to the entity may include providing the entity with a real-time update including a different entity visit time as compared to the original entity visit time.

The request may include a request to receive the one or more entity offerings at the specified location for the entity visit time.

Acceptance receiving module 116 may be configured to receive an acceptance from the entity to the user. The acceptance may include agreeing to provide the one or more entity offerings at the entity visit time.

Update sending module 118 may be configured to send one or more updates of the entity visit time from the user to the entity.

Update sending module 118 may be configured to send one or more updates for a status of the entity offerings from the entity to the user.

Portion providing module 120 may be configured to provide at least a portion the one or more entity offerings at the specified location at or near the entity visit time.

Payment providing module 122 may be configured to provide payment to the entity via a pre-paid account.

Comment providing module 124 may be configured to provide one or more comments from the user to the entity.

Incentive receiving module 126 may be configured to receive an incentive at the user from the entity. The incentive may be at least based in part on information obtained from a geolocation device.

User communication module 128 may be configured to communicate with one or more additional users to one of split the payment between the user and the one or more additional users, and locate the entity, the specified location, and the entity visit time for each of the user and the one or more additional users to receive the one or more entity offerings. By way of non-limiting example, the entity, specified location, and the entity visit time for each of the user and the one or more additional users may include the same entity, specified location, and the entity visit time. By way of non-limiting example, the entity visit time may be determined by one of a location device utilizing one or more geolocation devices and includes a time for the user to travel from a first location to the specified location via one or more modes of transportation, when a site at the specified location is available to the user at a date and time selected by the user. The one or modes of transportation may include walking and driving.

Providing at least a portion of the one or more entity offerings at the specified location at or near the entity visit time may include providing at least one of the menu options at a restaurant table at the dining reservation time.

Business offering providing module 130 may be configured to provide at least a portion of the one or more entity offerings at the specified location at or near the entity (or business) visit time includes providing the one or more entity offerings no more than three minutes after the entity (or business) visit time.

Table type agreeing module 132 may be configured to agree to leave the first table type after an agreed-to period of time.

Entity providing module 134 may be configured to provide at least one of the entity and the user with information related to a current time and the entity visit time before providing at least a portion of the one or more entity offerings at the specified location at or near the entity (or business) visit time.

Events module 136 may be configured to provide at least a portion of the entity for an event based at least in part on the request from the user to the entity. In some cases, the event may be an example of a social event, a work or employer event, a sporting event, or an event for people with common interests or tastes.

Social Media module 138 may be configured to send one or more social rewards and programs, advertisements or targeted marketing, and discount offers to the user from the entity.

In some implementations, the menu options may display a cook time associated with the menu option. In some implementations, the first table type may include a different table type than a regular table type.

In some implementations, server(s) 102, client computing platform(s) 104, and/or external resources 139 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 139 may be operatively linked via some other communication media.

A given client computing platform 104 may include one or more processors configured to execute computer program modules. The computer program modules may be configured to enable an expert or user associated with the given client computing platform 104 to interface with system 100 and/or external resources 139, and/or provide other functionality attributed herein to client computing platform(s) 104. By way of non-limiting example, the given client computing platform 104 may include one or more of a desktop computer, a laptop computer, a handheld computer, a tablet computing platform, a Netbook, a Smartphone, a gaming console, and/or other computing platforms.

External resources 139 may include sources of information outside of system 100, external entities participating with system 100, and/or other resources. In some implementations, some or all of the functionality attributed herein to external resources 139 may be provided by resources included in system 100.

Server(s) 102 may include electronic storage 138, one or more processors 140, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 138 may comprise non-transitory storage media that electronically stores information. The electronic storage media of electronic storage 138 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 138 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 138 may include one or more virtual storage resources (e.g., cloud storage, a virtual private network, and/or other virtual storage resources). Electronic storage 138 may store software algorithms, information determined by processor(s) 140, information received from server(s) 102, information received from client computing platform(s) 104, and/or other information that enables server(s) 102 to function as described herein.

Processor(s) 140 may be configured to provide information processing capabilities in server(s) 102. As such, processor(s) 140 may include one or more of a digital processor, an analog processor, a digital circuit designed to process information, an analog circuit designed to process information, a state machine, and/or other mechanisms for electronically processing information. Although processor(s) 140 is shown in FIG. 1 as a single entity, this is for illustrative purposes only. In some implementations, processor(s) 140 may include a plurality of processing units. These processing units may be physically located within the same device, or processor(s) 140 may represent processing functionality of a plurality of devices operating in coordination. Processor(s) 140 may be configured to execute modules 108, 110, 112, 114, 116, 118, 120, 122, 124, 126, 128, 130, 132, and/or 134, and/or other modules. Processor(s) 140 may be configured to execute modules 108, 110, 112, 114, 116, 118, 120, 122, 124, 126, 128, 130, 132, and/or 134, and/or other modules by software; hardware; firmware; some combination of software, hardware, and/or firmware; and/or other mechanisms for configuring processing capabilities on processor(s) 140. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, 118, 120, 122, 124, 126, 128, 130, 132, and/or 134 are illustrated in FIG. 1 as being implemented within a single processing unit, in implementations in which processor(s) 140 includes multiple processing units, one or more of modules 108, 110, 112, 114, 116, 118, 120, 122, 124, 126, 128, 130, 132, and/or 134 may be implemented remotely from the other modules. The description of the functionality provided by the different modules 108, 110, 112, 114, 116, 118, 120, 122, 124, 126, 128, 130, 132, and/or 134 described below is for illustrative purposes, and is not intended to be limiting, as any of modules 108, 110, 112, 114, 116, 118, 120, 122, 124, 126, 128, 130, 132, and/or 134 may provide more or less functionality than is described. For example, one or more of modules 108, 110, 112, 114, 116, 118, 120, 122, 124, 126, 128, 130, 132, and/or 134 may be eliminated, and some or all of its functionality may be provided by other ones of modules 108, 110, 112, 114, 116, 118, 120, 122, 124, 126, 128, 130, 132, and/or 134. As another example, processor(s) 140 may be configured to execute one or more additional modules that may perform some or all of the functionality attributed below to one of modules 108, 110, 112, 114, 116, 118, 120, 122, 124, 126, 128, 130, 132, and/or 134.

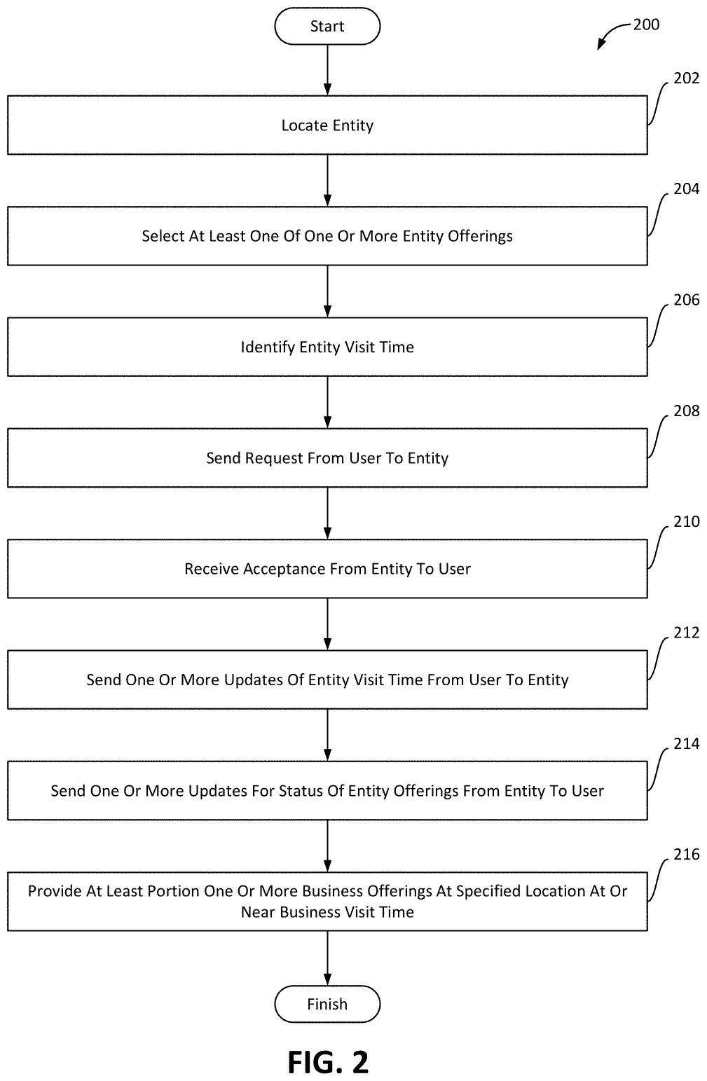

FIG. 2 illustrates a method 200 for decreasing business-to-consumer wait times, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include locating an entity. The entity may offer decreased wait times to receive one or more entity offerings at a specified location. Operation 202 may be performed by one or more hardware processors configured by machine-readable instructions including a module that is the same as or similar to entity location module 108, in accordance with one or more implementations.

An operation 204 may include selecting at least one of the one or more entity offerings. Operation 204 may be performed by one or more hardware processors configured by machine-readable instructions including a module that is the same as or similar to entity offering selection module 110, in accordance with one or more implementations.

An operation 206 may include identifying an entity visit time. Operation 206 may be performed by one or more hardware processors configured by machine-readable instructions including a module that is the same as or similar to entity visit time identifying module 112, in accordance with one or more implementations.

An operation 208 may include sending a request from a user to the entity. The request may include a request to receive the one or more entity offerings at the specified location for the entity visit time. Operation 208 may be performed by one or more hardware processors configured by machine-readable instructions including a module that is the same as or similar to request sending module 114, in accordance with one or more implementations.

An operation 210 may include receiving an acceptance from the entity to the user. The acceptance may include agreeing to provide the one or more entity offerings at the entity visit time. Operation 210 may be performed by one or more hardware processors configured by machine-readable instructions including a module that is the same as or similar to acceptance receiving module 116, in accordance with one or more implementations.

An operation 212 may include sending one or more updates of the entity visit time from the user to the entity. Operation 212 may be performed by one or more hardware processors configured by machine-readable instructions including a module that is the same as or similar to update sending module 118, in accordance with one or more implementations.

An operation 214 may include sending one or more updates for a status of the entity offerings from the entity to the user. Operation 214 may be performed by one or more hardware processors configured by machine-readable instructions including a module that is the same as or similar to update sending module 118, in accordance with one or more implementations.

An operation 216 may include providing at least a portion of the one or more entity offerings at the specified location at or near the entity (or business) visit time. Operation 216 may be performed by one or more hardware processors configured by machine-readable instructions including a module that is the same as or similar to portion providing module 120, in accordance with one or more implementations.

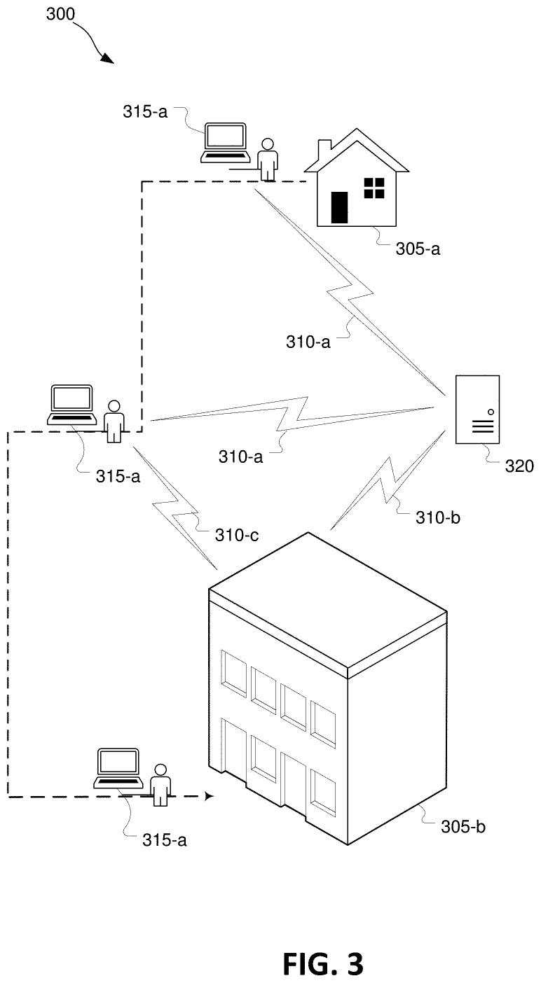

FIG. 3 illustrates a communication system 300, in accordance with one or more implementations. The communication system 300 may include a first location 305-a, a second location 305-b, a user 315-a, a server 320, and one or more communication links 310 (e.g., communication link 310-a, communication link 310-b, communication link 310-c, etc.). In some examples, the first location 305-a may be an initial or original location of the user 315-a, such as the user's home address, while the second location 305-b may be a location of an entity, such as a restaurant, a bar, or another location supporting business-to-consumer (B2C) commerce. In some cases, the user 315-a may be able to receive one or more entity offerings at the second location 305-b, wherein the entity offers decreased wait times to receive the one or more entity offerings at the second location 305-b at a visit time requested by the user.

As an example, the user 315-a (i.e., at the first location 305-a) may locate an entity at the second location 305-b via the system of the present disclosure. In some cases, the system may include an application running on a network connected device (e.g., smartphone, tablet, laptop, etc.) of the user 315-a. Further, the application may comprise one or more of search, location, geotracking, and feedback capabilities. In one example, the entity may be a restaurant, and the user 305-a may select from one or more filters (e.g., cuisine, price range, location to user, etc.) prior to locating the restaurant. Following locating the restaurant, the user 305-a may select at least one of the one or more menu offerings at the restaurant, customizations (if any), and a visit time for the restaurant. In some cases, the application may allow users to search entity offerings based on preparation time, calories, ingredients, special events or promotions, etc. For example, a user wishing to eat onion rings or meals incorporating onion rings may be able to search for entities that list onion rings on their menu, or alternatively, confirm if the entity they selected initially has onion rings. In either case, the application may apply the search keyword of “onion rings” and display a list of entities that serve onion rings, Rodeo Burgers, Onion Burgers, etc. In some other cases, users may be able to search entities or narrow down a list of entity offerings at an entity based on a preparation time (e.g., Restaurant A: <20 minutes, Restaurant B: 25-30 minutes, Chicken Tenders at Restaurant A: 5-7 minutes, show me entities or entity offerings less than 10 minutes, etc.). In some aspects, providing users with insights on how long they should expect to be done with their meal may enable them to make more informed decisions. In some cases, the approximate preparation time listed in the application may be updated in real-time based on data obtained from entities, such as the number patrons already at the entity, number of available tables, understaffing issues, etc. In some other case the users could search for “kids” to show establishments that have a menu for children. In some other case the users could search for “kids specials” to show establishments where kids eat free or at a reduced rate near the user today or on a particular day and time.

In some examples, the user 305-a may then send a request to the restaurant over communication links 310-a and 310-b. Specifically, the request may be sent, from the user, to server 320 via communication link 310-a. Further, the server 320 may forward or relay the request to the restaurant (or entity) via communication link 310-b. In some other cases, the user 305-a may directly (i.e., via communication link 310-c) send the request to the restaurant.

In some cases, the restaurant (or entity) may review the request transmitted by the user 305-a and transmit an acceptance to the user, where the acceptance comprises agreeing to provide the one or more offerings at the visit time requested by the user. Similar to the transmittal request, the acceptance may be transmitted over communication links 310-b and 310-a (i.e., via server 320), or may be sent directly (i.e., via communication link 310-c) to the user 305-a.

In some embodiments, if the user 305-a has authorized permission for real-time tracking, the restaurant may receive one or more updates of the entity visit time from the user 305-a. In one example, the restaurant may receive an update or notification pertaining to a late (e.g., due to traffic) or early arrival (e.g., shortcut used) of the user 305-a. In such cases, the restaurant (or entity) may plan the meal preparation based on the same. For instance, if the restaurant or entity receives a first update pertaining to a late arrival of a first user and a second update pertaining to an early arrival of a second user, the restaurant may arrange for the second user's order to be handled first. Additionally or alternatively, the user 305-a may also receive real-time updates or notifications pertaining to a status of their meal (e.g., food ready, food is on grill, burger needs 10 more minutes, etc.) from the restaurant at location 305-b.

Following arrival, in some cases, the user 305-a may be provided with at least a portion of the one or more meals (or entity offerings) at location 305-b at or near the requested visit time.

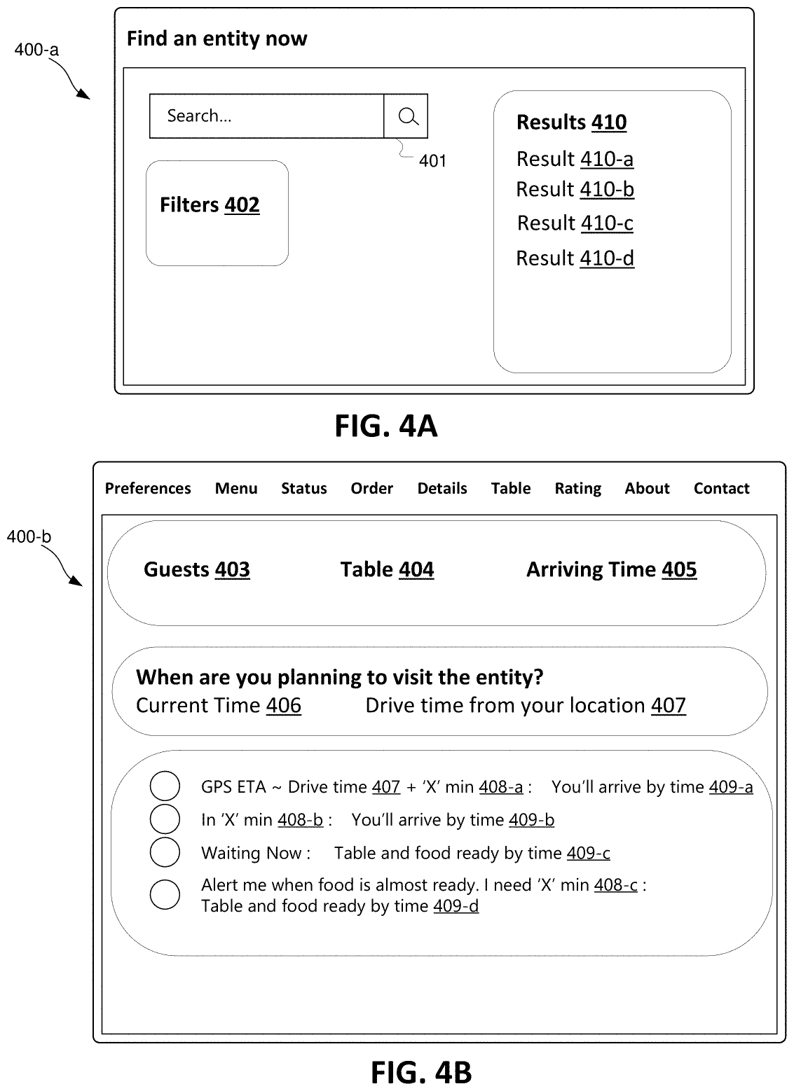

FIGS. 4-8 illustrate example visualizations of the application screen as seen on a connected device, in accordance with one or more implementations. In some examples, the connected device may be owned or operated by the customer or user, restaurant manager, server, bartender, or another staff member at the entity.

FIG. 4A illustrates a visualization of a screen 400-a for a user searching or locating an entity according to various embodiments of the disclosure. In some cases, the user may be an example of the user 305-a, as described with reference to FIG. 3. In one example, the entity may be a restaurant, although the entity may be any business supporting B2C commerce. Examples of entities may include cellphone stores, automobile mechanics, tire stores, barbers or hair salons, nail spas, etc. While some of these entities allow customers to make reservations or book a spot in advance, the booking process often requires the customer to call multiple entities or use different apps for different services. Besides the frustrating booking process, customers also have to endure long wait times to receive services that meet their needs (e.g., if the entity or a person providing a service at the entity is in high demand). Lastly, these booking systems also lack real-time location tracking and feedback.

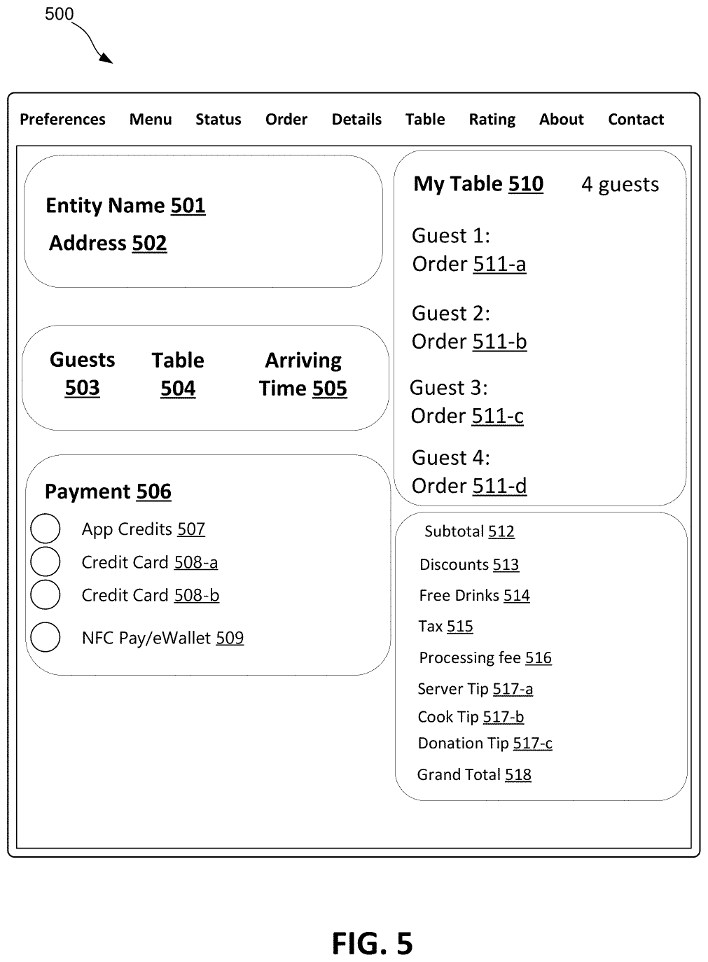

As illustrated, screen 400-a may include search capabilities (i.e., search bar 401) and one or more filters 402 for locating an entity, such as a restaurant. In some cases, after the user enters in one or more search keywords or industry specific search fields into the search bar, the screen 400-a may display one or more results 410 (i.e., result 410-a, result 410-b, result 410-c, result 410-d, etc.). In some examples, the user may also have the option of narrowing down the results 410 displayed on the screen 400-a by selecting the one or more filters 402. In other words, the filters 402 may provide the user the ability to only view entities meeting their particular needs. For instance, the filters 402 may comprise a location or proximity (e.g., within 1 mile, within 5 miles, etc.) to the user, rating (e.g., 4 stars and above, at least 3 stars, etc.), cuisine type (e.g., French, Italian, BBQ, etc.), price range (e.g., <$10/meal, <25$/meal, etc.), and one or more additional options (e.g., Vegetarian/Vegan options, Paleo options, Gluten Free options, etc.). In some cases, the user may have the option of selecting more than one filter while locating an entity. For example, the user may be able to view entities that are within 5 miles and have at least 4 stars. After selecting an entity (or restaurant) from the results 410, the user may then proceed to place an order with the entity, as further described with reference to FIGS. 4B and 5.

FIG. 4B illustrates a visualization of a screen 400-b for a user locating and selecting an entity using the JiT system or application according to various embodiments of the disclosure. In some cases, screen 400-b may also include provisions for location services (e.g., GPS based, WiFi based, etc.). As shown, a user may place an order by indicating one or more of: the number and/or names of guests, as well as the order for each guest (i.e., guests 403), type of table (i.e., table 404), as well as an arriving time 405. In some examples, the type of table may include a request for a family table, a table different from a regular table, a shared table, bar seating, etc. Further, the system or application may allow the user to set preferences for the type of table, such as booth seating, no kids on shared table, pair shared table with patrons of similar interests, etc. In some cases, the system may match users for shared tables based on their interests. In this way, users may not need to know each other prior to being seated. In some examples, if mobile location services are turned on, location tracking may be used to calculate the time to reach the entity. That is, the arriving time 405 may be automatically calculated by the application based on a GPS estimate. For instance, the arrival time may be calculated using current time 406 and drive time from location 407.

In other cases, the application may utilize an optimization platform, where the optimization platform allows the user to adjust the ETA to a later or an earlier time. In some cases, the optimization platform may allow the user to override the GPS ETA in order to factor in scenarios such as, but not limited to, the user not in their car or not ready to depart yet, the user is aware of a shortcut to the restaurant, the user needs to find parking near the restaurant and walk a few blocks, etc. In such cases, the user may be prompted to choose from one or more ETA options described below. In a first option, the user may indicate their plan to visit the entity at an additional time (i.e., ‘X’ minutes 408-a) after their drive time. In such cases, the system may indicate to the user that their anticipated arrival time is time 409-a (i.e., current time 406+drive time 407+‘X’ min 408-a), and that their order would be ready no more than a particular time duration (e.g., 3 minutes, 5 minutes, etc.) after their arrival.

In a second option, the user may indicate that they will arrive at the entity at an additional time (i.e., ‘X’ minutes 408-b) after the current time 406. In such cases, the system may indicate to the user that their anticipated arrival time is time 409-b (i.e., current time 406+‘X’ min 408-b), and that their order would be ready no more than a particular time duration (e.g., 3 minutes, 5 minutes, etc.) after their arrival. In some examples, the arriving time 405 displayed to the user may be one of time 409-a or time 409-b, based on the first or second option selected by the user.

In some other cases, the user may indicate that they are already at the establishment. In such cases, the system may indicate to the user that their table and food ready will be ready by time 409-c. In some circumstances, a customer at the entity may not be aware of the JiT system or application of this disclosure, and upon arrival, may be notified that a wait time for a table is on the order of 30-40 minutes. In one example, the customer may learn about the JiT system from talking to a staff member, or a current user of the system. In such cases, after the customer joins the JiT application as a new user, they may realize that by utilizing the system for requesting a table, placing orders, paying, etc., their food and drinks could be ready in about the same time (˜30-40 minutes) as it would take for merely getting a table using conventional means.

In yet other cases, the user may request the restaurant (or entity) to alert them when their food is ready, and that they would need ‘X’ minutes 408-c to arrive at the entity. In such cases, the system may indicate to the user that their table and food would be ready by time 409-d.

In some examples, the user may have the option to entirely override the GPS ETA, or may not have enabled GPS services on their network connected device. In such cases, the user may notify the restaurant of an approximate amount of time it would take for them to arrive at the restaurant. In some other cases, the user may also have the option to schedule their booking or reservation for a date/time in advance (e.g., 90 minutes from now, 4 hours from now, 1 day from now, etc.). It should be noted that regardless of the option selected by the user, an actual date/time of arrival may be calculated by the application and displayed to the user. In some cases, a scheduling module of the application or system may be configured to integrate with a calendar application (e.g., GOOGLE calendar, OUTLOOK calendar, etc.) on the user's network connected device, and add the booking or reservation to the same, either automatically, or after user confirmation. Further, the application or system may allow the user to set a reminder or alarm for their reservation. In some examples, the application or system may also prompt users with discounts or promos (e.g., Wing Wednesday, Taco Tuesday, kids eat free tonight, etc.) at certain entities. In some instances, the system may add reminders for these recurring or one-off promos to the user's calendar, and may allow the user to request a table, place an order, etc., for these special events.

In another example, the application or system may allow the user to schedule events for small or large parties (e.g., 2 people, 10 people, 50 people, etc.) for a specific time and date, as well as take individual orders for each user or member of the party. In some cases, the entity or restaurant may promise to have at least a portion of the orders ready at the agreed upon time. In some cases, users may also schedule recurring events (e.g., weekly book club) with an entity through the JiT system. Further, users may have the option of requesting separate checks, or splitting the check by the number of people on the table, etc., via the application.

Additionally or alternatively, the system may also support the creation of waitstaff or cook schedules, which may be accessed by staff members through a mobile app or other means. In some cases, the system may notify staff members that extra help would be welcome due to a large booking. In some other cases, staff members may view their schedule, shifts selected, etc. through the application, and may also receive reminders about the same. The application may also allow staff members to trade shifts with one another, or message the manager (e.g., for a last-minute shift cancel request). In some cases, back of house (i.e., cook staff) may also receive reminders, which may be tied to orders or events. For instance, a chef may receive a reminder to cook the shrimp or pasta once the steak is nearing 50% doneness.

FIG. 5 illustrates a visualization of a screen 500 for a user placing an order with the entity according to various embodiments of the disclosure. As shown, after locating and selecting the entity in FIGS. 4A and 4B, the JiT application on the user's network connected device may display an entity name 501, an address 502, guests 503, table 504, and an arriving time 505. In some examples, the guests 503, table 504, and arriving time 505 displayed on screen 500 may be examples of the guests 403, table 404, and arriving time 405, as described with reference to FIG. 4B. In some examples, screen 500 may also display the names of the guests and/or pictures under guests 403, allowing a server to identify the user and party when they walk in, or provide a more personal experience to the user.

In some circumstances, screen 500 may also serve as the order confirmation and payment screen. For instance, as seen in the upper right pane of screen 500, the user may be able to view the order and customizations (if any) for each guest (i.e., order 511-a for Guest 1, order 511-b for Guest 2, order 511-c for Guest 3, order 511-d for Guest 4) on their table (i.e., My Table 510). In some embodiments, the user may also be given the option to cancel, replace, or make any modifications/customizations to the orders prior to submission. As seen in the lower right pane of screen 500, the user may be able to view a detailed receipt for the order including a subtotal 512, discounts (optional) 513, free drinks (optional) 514, tax 515, processing fee 516, tips 517 (e.g., server tip 517-a, cook tip 517-b, donation tip 517-c), and a grand total 518. In some cases, the user may be given the option for tips 517 to be auto-calculated based on subtotal 512. In some other cases, the user may select a tip percentage (e.g., 10%, 20%, 25%, etc.) from a drop-down list or may enter the tips 517 manually.

After confirming and viewing the grand total 518 for the order, the user may proceed to setup payment 506. In some cases, the user may select to pay for the order using app credits 507 (e.g., if the user is a recurring user). In some other cases, the user may add credit cards (e.g., credit card 508-a, credit card 508-b) to their account, and pay using one of those. In yet other cases, the user may pay for their order using Near Field Communication (NFC) Pay/eWallet 509. The system or application may allow users to setup any of the payment options described above as a default option for faster check out in the future. Further, the system may also allow the order to be split up amongst multiple users (e.g., based on the individual orders or split the check equally). In some circumstances, after the user has submitted the order, the application or entity may place a hold charge on the user's account for a set amount (e.g., entire check amount and 10% tip, 50% of check amount, etc.), which may serve to protect the entity if the user does not show up. In some embodiments, the user may have the option to contact the restaurant or the application for a refund due to a no-show.

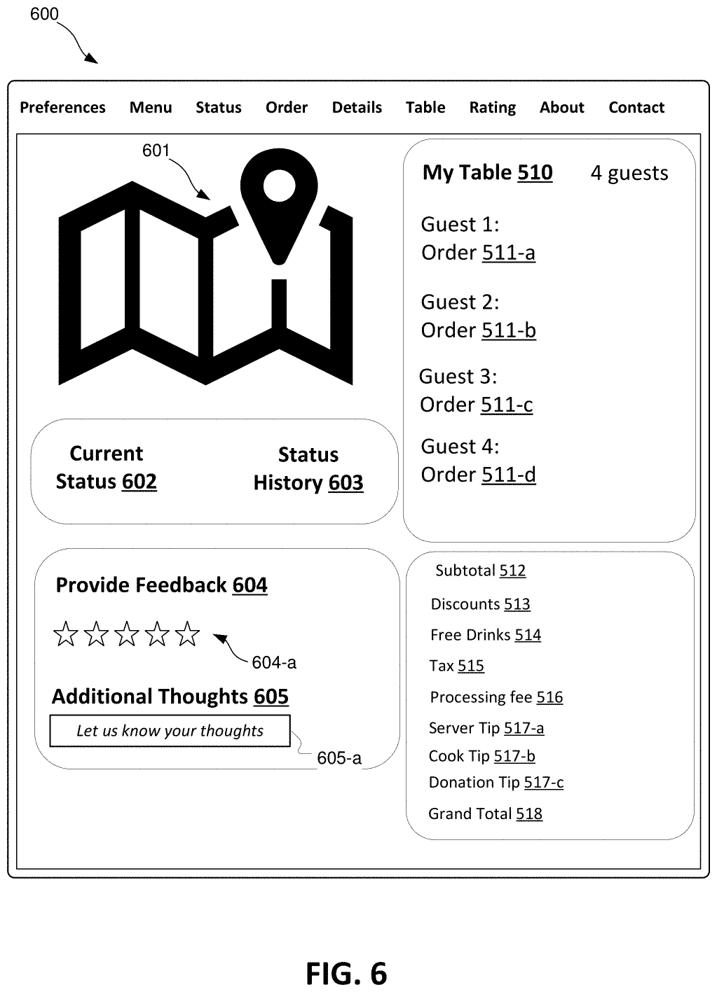

FIG. 6 illustrates a visualization of a screen 600 for a user receiving a confirmation of the order and tracking status of the order according to various embodiments of the disclosure.

After confirming and paying for the order in FIG. 5, the application may allow the user to track the status of their order and provide feedback. As illustrated, screen 600 may display a map 601, which may include at least a pin (or marker) for locating the entity on the map. In some cases, the map 601 may also display a pin for the current location of the user and provide navigation directions (i.e., walking, driving, public transport, bicycle, etc.) to the entity from the user's location. Further, screen 600 may display a current status 602 and status history 603 for My Table 510, which may be the same as My Table 510 of FIG. 5. In some cases, the current status 602 and/or status history 603 may comprise a name of the cook, current time, cooking duration, target hit (i.e., Yes or No), etc. Furthermore, the application may also allow the user to provide feedback 604 (e.g., star feedback 604-a) for their cook or their overall experience at the entity. In some cases, the user may also be prompted to give additional thoughts 605, which may be input via a textbox 605-a.

In some embodiments, the user may be able to flag their server through the application, for instance, to add items to their order. In some cases, the additional items may be automatically added to the user's initial order before or during payment (i.e., if the restaurant had not placed a hold charge). In some cases, the final payment may be processed after the user has finished their meal. In other cases, the user may have the option of completing a second payment transaction for the additional items ordered via the application.

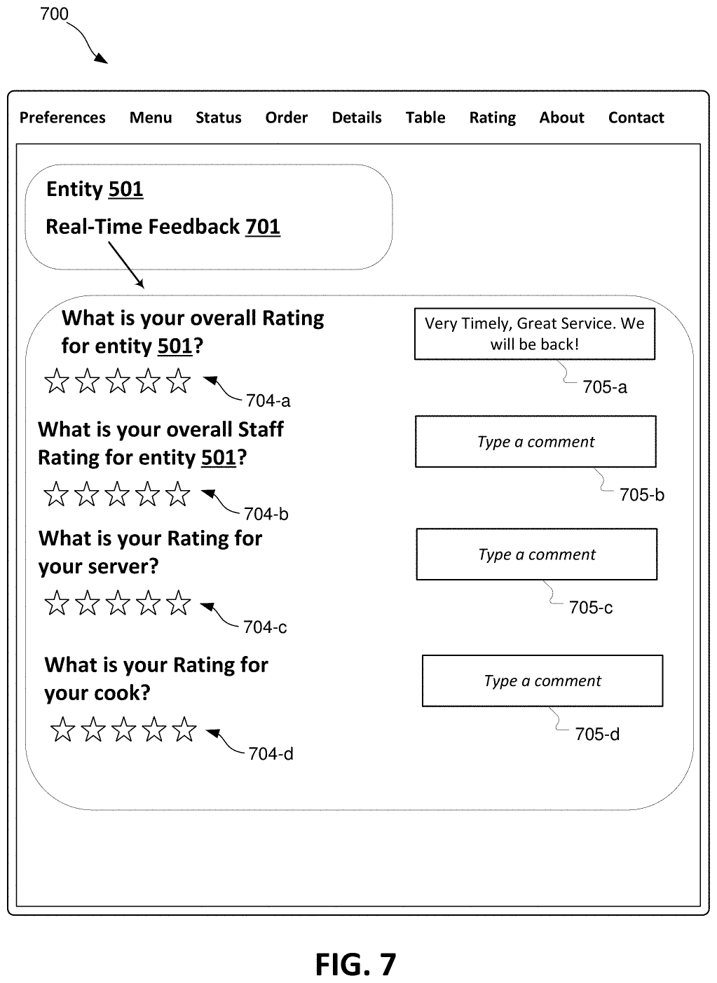

FIG. 7 illustrates a visualization of a screen 700 for a user providing real-time feedback 701 for entity 501 according to various embodiments of the disclosure. As illustrated, a user may be prompted to provide real-time feedback 701 for their experience at the entity, which may include food quality, service, value for money, rating for their server, rating for their cook, etc. In some embodiments, the user may provide star feedback 704 (e.g., star feedback 704-a, 704-b, 704-c, 704-d, etc.) for the one or more questions displayed under the real-time feedback 701 portion of screen 700. Further, the user may also type or write out one or more comments in textboxes 705 (e.g., textbox 705-a, 705-b, 705-c, 705-d, etc.) for providing more detailed feedback to the entity 501. While not shown, in some cases, the real-time feedback 701 portion of screen 700 may also allow the user to provide a video testimonial or add pictures related to their experience at the entity 501. In some cases, the user may record and upload the video testimonial using their connected network device, such as a smartphone or a tablet.

For instance, users of the system may capture videos or images of their favorite meals to share with their friends or followers on social media. In some examples, users may be able to link their JiT accounts with their social media handles, allowing other users to look them up easily, read their reviews and recommendations, etc. In some embodiments, the system may give users access to a video vault (e.g., cloud based or web-based), and users may be able to view videos and other multimedia posted by others. In some cases, users may be able to create collages or slideshows of pictures of their favorite meals, stream live videos of events, etc. In some cases, the social media sharing platform could be the JiT optimization platform itself.

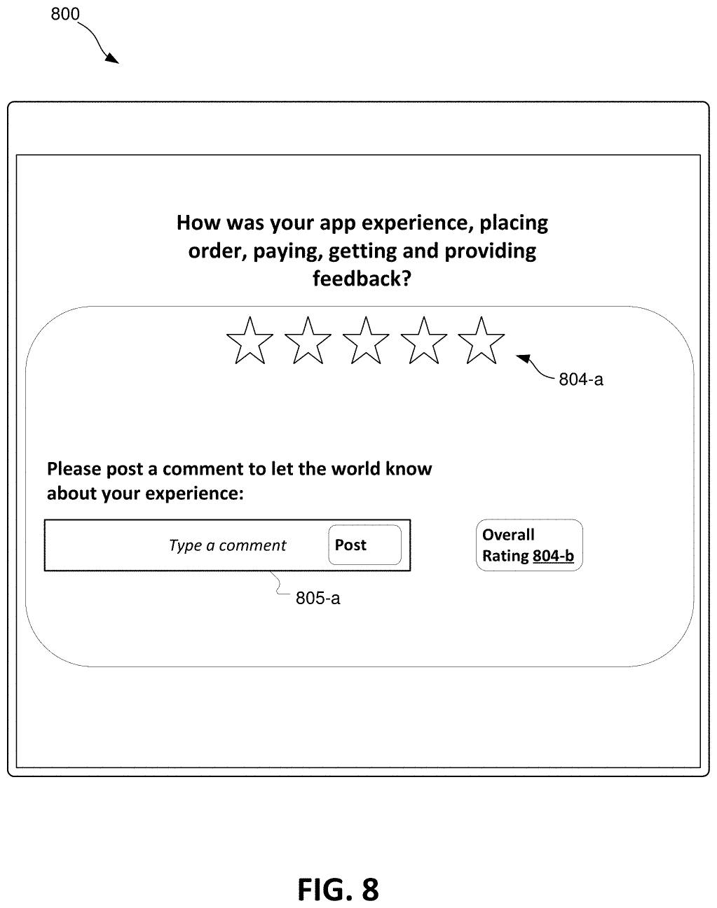

FIG. 8 illustrates a visualization of a screen 800 for a customer providing real-time feedback for the JiT application or system according to various embodiments of the disclosure. As illustrated, a user may be prompted to provide real-time feedback for their experience with the application, which may include ease of use, placing orders, paying, getting and providing feedback, etc. In some embodiments, the user may provide star feedback 804-a for the one or more questions displayed on their screen. Further, the user may also type or write out one or more comments in textbox 805-a for providing more detailed feedback about their experience with the application to current or future users. In some embodiments, the screen 800 may also display an overall rating 804-b based on aggregating star feedback 804 scores from other users who have rated the JiT application. It should be noted that while FIGS. 7 and 8 illustrate the feedback as star feedback on a 1 to 5 scale, any other type of feedback or scale may be used, such as, but not limited to, a 1 to 10 scale, an A/B/C/D/F scale, an Excellent/Great/Good/Poor scale, etc.

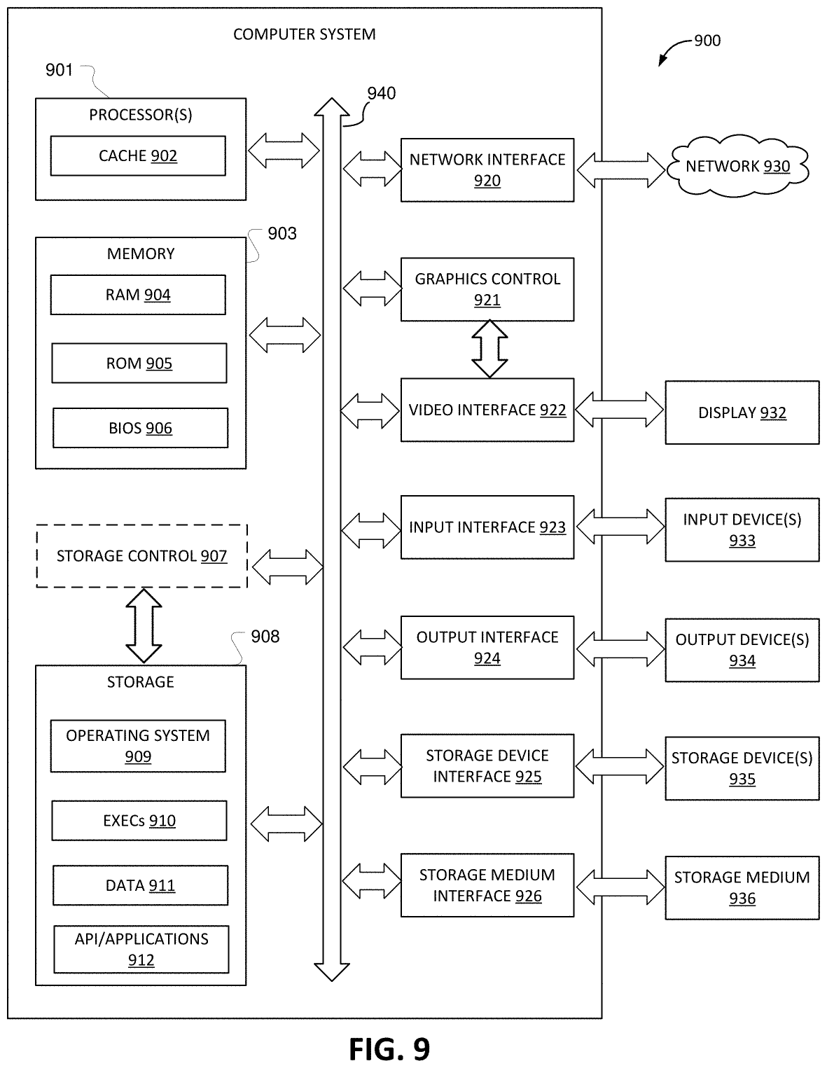

FIG. 9 illustrates a diagrammatic representation of one embodiment of a computer system 900, within which a set of instructions can execute for causing a device to perform or execute any one or more of the aspects and/or methodologies of the present disclosure. The components in FIG. 9 are examples only and do not limit the scope of use or functionality of any hardware, software, firmware, embedded logic component, or a combination of two or more such components implementing particular embodiments of this disclosure. Some or all of the illustrated components can be part of the computer system 900. For instance, the computer system 900 can be a general-purpose computer (e.g., a laptop computer) or an embedded logic device (e.g., an FPGA), to name just two non-limiting examples.

Moreover, the components may be realized by hardware, firmware, software or a combination thereof. Those of ordinary skill in the art in view of this disclosure will recognize that if implemented in software or firmware, the depicted functional components may be implemented with processor-executable code that is stored in a non-transitory, processor-readable medium such as non-volatile memory. In addition, those of ordinary skill in the art will recognize that hardware such as field programmable gate arrays (FPGAs) may be utilized to implement one or more of the constructs depicted herein.

Computer system 900 includes at least a processor 901 such as a central processing unit (CPU) or a graphics processing unit (GPU) to name two non-limiting examples. Any of the subsystems described throughout this disclosure could embody the processor 901. The computer system 900 may also comprise a memory 903 and a storage 908, both communicating with each other, and with other components, via a bus 940. The bus 940 may also link a display 932, one or more input devices 933 (which may, for example, include a keypad, a keyboard, a mouse, a stylus, etc.), one or more output devices 934, one or more storage devices 935, and various non-transitory, tangible computer-readable storage media 936 with each other and/or with one or more of the processor 901, the memory 903, and the storage 908. All of these elements may interface directly or via one or more interfaces or adaptors to the bus 940. For instance, the various non-transitory, tangible computer-readable storage media 936 can interface with the bus 940 via storage medium interface 926. Computer system 900 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 901 (or central processing unit(s) (CPU(s))) optionally contains a cache memory unit 932 for temporary local storage of instructions, data, or computer addresses. Processor(s) 901 are configured to assist in execution of computer-readable instructions stored on at least one non-transitory, tangible computer-readable storage medium. Computer system 900 may provide functionality as a result of the processor(s) 901 executing software embodied in one or more non-transitory, tangible computer-readable storage media, such as memory 903, storage 908, storage devices 935, and/or storage medium 936 (e.g., read only memory (ROM)). Memory 903 may read the software from one or more other non-transitory, tangible computer-readable storage media (such as mass storage device(s) 935, 936) or from one or more other sources through a suitable interface, such as network interface 920. Any of the subsystems herein disclosed could include a network interface such as the network interface 920. The software may cause processor(s) 901 to carry out one or more processes or one or more steps of one or more processes described or illustrated herein. Carrying out such processes or steps may include defining data structures stored in memory 903 and modifying the data structures as directed by the software. In some embodiments, an FPGA can store instructions for carrying out functionality as described in this disclosure. In other embodiments, firmware includes instructions for carrying out functionality as described in this disclosure.

The memory 903 may include various components (e.g., non-transitory, tangible computer-readable storage media) including, but not limited to, a random-access memory component (e.g., RAM 904) (e.g., a static RAM “SRAM”, a dynamic RAM “DRAM, etc.), a read-only component (e.g., ROM 909), and any combinations thereof. ROM 909 may act to communicate data and instructions unidirectionally to processor(s) 901, and RAM 904 may act to communicate data and instructions bidirectionally with processor(s) 901. ROM 909 and RAM 904 may include any suitable non-transitory, tangible computer-readable storage media. In some instances, ROM 909 and RAM 904 include non-transitory, tangible computer-readable storage media for carrying out a method. In one example, a basic input/output system 906 (BIOS), including basic routines that help to transfer information between elements within computer system 900, such as during start-up, may be stored in the memory 903.

Fixed storage 908 is connected bi-directionally to processor(s) 901, optionally through storage control unit 907. Fixed storage 908 provides additional data storage capacity and may also include any suitable non-transitory, tangible computer-readable media described herein. Storage 908 may be used to store operating system 909, EXECs 910 (executables), data 911, API applications 912 (application programs), and the like. Often, although not always, storage 908 is a secondary storage medium (such as a hard disk) that is slower than primary storage (e.g., memory 903). Storage 908 can also include an optical disk drive, a solid-state memory device (e.g., flash-based systems), or a combination of any of the above. Information in storage 908 may, in appropriate cases, be incorporated as virtual memory in memory 903.

In one example, storage device(s) 935 may be removably interfaced with computer system 900 (e.g., via an external port connector (not shown)) via a storage device interface 925. Particularly, storage device(s) 935 and an associated machine-readable medium may provide nonvolatile and/or volatile storage of machine-readable instructions, data structures, program modules, and/or other data for the computer system 900. In one example, software may reside, completely or partially, within a machine-readable medium on storage device(s) 935. In another example, software may reside, completely or partially, within processor(s) 901.

Bus 940 connects a wide variety of subsystems. Herein, reference to a bus may encompass one or more digital signal lines serving a common function, where appropriate. Bus 940 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 900 may also include an input device 933. In one example, a user of computer system 900 may enter commands and/or other information into computer system 900 via input device(s) 933. Examples of an input device(s) 933 include, but are not limited to, an alpha-numeric input device (e.g., a keyboard), a pointing device (e.g., a mouse or touchpad), a touchpad, a touch screen and/or a stylus in combination with a touch screen, a joystick, a gamepad, an audio input device (e.g., a microphone, a voice response system, etc.), an optical scanner, a video or still image capture device (e.g., a camera), and any combinations thereof. Input device(s) 933 may be interfaced to bus 940 via any of a variety of input interfaces 923 (e.g., input interface 923) including, but not limited to, serial, parallel, game port, USB, FIREWIRE, THUNDERBOLT, or any combination of the above.

In particular embodiments, when computer system 900 is connected to network 930, computer system 900 may communicate with other devices, such as mobile devices and enterprise systems, connected to network 930. Communications to and from computer system 900 may be sent through network interface 920. For example, network interface 920 may receive incoming communications (such as requests or responses from other devices) in the form of one or more packets (such as Internet Protocol (IP) packets) from network 930, and computer system 900 may store the incoming communications in memory 903 for processing. Computer system 900 may similarly store outgoing communications (such as requests or responses to other devices) in the form of one or more packets in memory 903 and communicated to network 930 from network interface 920. Processor(s) 901 may access these communication packets stored in memory 903 for processing.

Examples of the network interface 920 include, but are not limited to, a network interface card, a modem, and any combination thereof. Examples of a network 930 or network segment 930 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 930, may employ a wired and/or a wireless mode of communication. In general, any network topology may be used.

Information and data can be displayed through a display 932. Examples of a display 932 include, but are not limited to, a liquid crystal display (LCD), an organic liquid crystal display (OLED), a cathode ray tube (CRT), a plasma display, and any combinations thereof. The display 932 can interface to the processor(s) 901, memory 903, and fixed storage 908, as well as other devices, such as input device(s) 933, via the bus 940. The display 932 is linked to the bus 940 via a video interface 922, and transport of data between the display 932 and the bus 940 can be controlled via the graphics control 921.

In addition to a display 932, computer system 900 may include one or more other peripheral output devices 934 including, but not limited to, an audio speaker, a printer, a check or receipt printer, and any combinations thereof. Such peripheral output devices may be connected to the bus 940 via an output interface 924. Examples of an output interface 924 include, but are not limited to, a serial port, a parallel connection, a USB port, a FIREWIRE port, a THUNDERBOLT port, and any combinations thereof. In some examples, the peripheral output devices may be used to generate reports for the entity, such as, but not limited to, financial reports, feedback reports, inventory reports, etc. For instance, the manager or another staff member at the entity may print a financial report including the amount of revenue for a particular day or time period, tips collected by each server or cook, profit margin, etc. In some other cases, servers may utilize the printer to print food orders that the cook staff may work off of.

In addition, or as an alternative, computer system 900 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a non-transitory, tangible computer-readable medium may encompass a circuit (such as an IC) storing software for execution, a circuit embodying logic for execution, or both, where appropriate. The present disclosure encompasses any suitable combination of hardware, software, or both.

Those of skill in the art will understand that information and signals may be represented using any of a variety of different technologies and techniques. Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, a software module implemented as digital logic devices, or in a combination of these. A software module may reside in RAM memory, flash memory, ROM memory, EPROM memory, EEPROM memory, registers, hard disk, a removable disk, a CD-ROM, or any other form of non-transitory, tangible computer-readable storage medium known in the art. An exemplary non-transitory, tangible computer-readable storage medium is coupled to the processor such that the processor can read information from, and write information to, the non-transitory, tangible computer-readable storage medium. In the alternative, the non-transitory, tangible computer-readable storage medium may be integral to the processor. The processor and the non-transitory, tangible computer-readable storage medium may reside in an ASIC. The ASIC may reside in a user terminal. In the alternative, the processor and the non-transitory, tangible computer-readable storage medium may reside as discrete components in a user terminal. In some embodiments, a software module may be implemented as digital logic components such as those in an FPGA once programmed with the software module.

It is contemplated that one or more of the components or subcomponents described in relation to the computer system 900 shown in FIG. 9 such as, but not limited to, the network 930, processor 901, memory, 903, etc., may comprise a cloud computing system. In one such system, front-end systems such as input devices 933 may provide information to back-end platforms such as servers (e.g. computer systems 900) and storage (e.g., memory 903). Software (i.e., middleware) may enable interaction between the front-end and back-end systems, with the back-end system providing services and online network storage to multiple front-end clients. For example, a software-as-a-service (SAAS) model may implement such a cloud-computing system. In such a system, users may operate software located on back-end servers through the use of a front-end software application such as, but not limited to, a web browser.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured for optimizing business-to-consumer wait times, the system comprising one or more hardware processors configured by machine-readable instructions to:
locate an entity via a network connected device, wherein,
the entity offers a plurality of tables,
the plurality of tables comprise a first table type and a remainder of the plurality of tables comprise a second table type,
the first table type comprises a table only available for reservation upon the entity receiving, via the network connected device:
an entity visit time,
an order for one or more entity offerings, and
a leave time,
the entity provides decreased wait times to receive the one or more entity offerings at a specified location on the first table type as compared to wait times to receive the one or more entity offerings at the specified location on the second table type;
receive, from the entity, an approximate preparation time for at least a portion of the one or more entity offerings, the approximate preparation time based at least in part on a number of available tables of the first table type and a number of patrons at the entity, and wherein the approximate preparation time is displayed via the network connected device;
select at least one of the one or more entity offerings via the network connected device;
identify the entity visit time for receiving the one or more entity offerings at the specified location on the first table type, wherein the entity visit time is at or after an entity offering ready time, and wherein the one or more entity offerings are ready at the entity offering ready time;
send a request from a user to the entity, wherein the request comprises a request to receive the one or more entity offerings at the specified location on the first table type for the entity visit time, and wherein the request is sent via the network connected device;
receive, at the network connected device, an acceptance from the entity to the user, wherein the acceptance comprises agreeing to provide the one or more entity offerings at the entity visit time; and
send one or more updates of the entity visit time from the user to the entity, wherein the one or more entity visit time updates are sent via the network connected device, and comprise one of a late arrival and an early arrival, wherein the late arrival or the early arrival are based at least in part upon traffic information and information obtained from a geolocation device of the network connected device.

2. The system of claim 1, wherein the one or more hardware processors are further configured by machine-readable instructions to,
send one or more updates for a status of the entity offerings from the entity to the user, and
locate an entity based on at least one of a keyword search and an industry-specific search, and wherein locating an entity comprises at least one of finding an entity in a specified area and finding an entity in a proximity to the user.

3. The system of claim 1, wherein the entity visit time is determined by a time for the user to travel from a first location to the specified location via one or more modes of transportation when one of the first table type and the second table type at the specified location is available to the user at a date and time selected by the user.

4. The system of claim 3, wherein the one or modes of transportation comprise walking and driving.

5. The system of claim 2, wherein the one or more hardware processors are further configured by machine-readable instructions to:
provide payment to the entity via a pre-paid account;
provide one or more comments from the user to the entity;
receive an incentive at the user from the entity, wherein the incentive is at least based in part on information obtained from the geolocation device of the network connected device;
communicate with one or more additional users to one of split the payment between the user and the one or more additional users;
locate the entity and the specified location;
determine the entity visit time for each of the user and the one or more additional users to receive the one or more entity offerings;
wherein the entity, specified location, and the entity visit time for each of the user and the one or more additional users comprise the same entity, specified location, and the entity visit time; and
provide at least a portion of the one or more entity offerings at the specified location at or near the entity visit time or an updated entity visit time, the updated entity visit time based at least in part on the one or more entity visit time updates,
wherein providing at least a portion of the one or more entity offerings at the specified location at or near the entity visit time or the updated entity visit time comprises providing the one or more entity offerings no more than three minutes after the entity visit time or the updated entity visit time.

6. The system of claim 5, wherein,
the entity comprises a restaurant;
the one or more entity offerings comprise menu options;
each of the menu options display a cook time associated with the menu option;
the entity visit time or the updated entity visit time comprises a dining reservation time;
providing at least a portion of the one or more entity offerings at the specified location at or near the entity visit time or the updated entity visit time comprises placing at least one of the menu options at a Just In Time table at or before the dining reservation time, wherein the Just In Time comprises the first table type;
sending one or more updates for a status of the entity offerings from the entity to the user comprises sending at least one of a table reserved notification, a menu item on the table notification, a menu item being prepared notification, and a menu item ready in an identified time notification;
providing one or more comments from the user to the entity comprises at least one of contacting an identified restaurant staff member or group, updating the one or more entity offerings, a table reserved rating, a menu item on the table rating, a menu item being prepared rating, a menu item ready in an identified time rating;
providing payment to the entity via a pre-paid account comprises enabling a direct payment to the identified restaurant staff member or group and identifying a cost associated with each menu option associated with the user and the one or more additional users; and
the request further comprises agreeing to leave the first table type after an agreed-to period of time requesting a first table type, wherein the agreed to period of time ends at or near the leave time, and wherein the first table type comprises a different table type than the second table type and the second table type comprises a regular table type.

7. The system of claim 1, wherein the entity visit time comprises an original entity visit time;
wherein sending one or more updates of the entity visit time from the user to the entity comprises providing the entity with a real-time update comprising a different entity visit time as compared to the original entity visit time, and wherein the different entity visit time comprises an updated entity visit time; and
wherein the one or more hardware processors are further configured by machine-readable instructions to provide at least one of the entity and the user with information related to a current time, the entity offering ready time, and the entity visit time or the updated entity visit time before providing at least a portion of the one or more entity offerings at the specified location at or near the entity visit time or the updated entity visit time, and wherein the entity offering ready time is based at least in part on the approximate preparation time.

8. A method for optimizing business-to-consumer wait times, the method comprising:
locating an entity via a network connected device, wherein the entity offers a plurality of tables resources, the plurality of tables comprise a first table type and a remainder of the plurality of tables comprise a second table type, the first table type comprises a table only available for reservation upon the entity receiving, via the network connected device:
an entity visit time,
an order for one or more entity offerings, and
a leave time, and wherein the entity provides decreased wait times to receive the one or more entity offerings at a specified location on the first table type as compared to wait times to receive the one or more entity offerings at the specified location on the second table type;
receiving, from the entity, an approximate preparation time for at least a portion of the one or more entity offerings, the approximate preparation time based at least in part on a number of available tables of the first table type and a number of patrons at the entity, and wherein the approximate preparation time is displayed via the network connected device;
selecting at least one of the one or more entity offerings via the network connected device;
identifying the entity visit time for receiving the one or more entity offerings at the specified location on the first table type, wherein the entity visit time is at or after an entity offering ready time, and wherein the one or more entity offerings are ready at the entity offering ready time;
sending a request from a user to the entity, wherein the request comprises a request to receive the one or more entity offerings at the specified location on the first table type for the entity visit time, and wherein the request is sent via the network connected device;
receiving, at the network connected device, an acceptance from the entity to the user, wherein the acceptance comprises agreeing to provide the one or more entity offerings at the entity visit time; and
sending one or more updates of the entity visit time from the user to the entity, wherein the one or more entity visit time updates are sent via the network connected device, and comprise one of a late arrival and an early arrival, wherein the late arrival or the early arrival are based at least in part upon traffic information and information obtained from a geolocation device of the network connected device.

9. The method of claim 8, further comprising:
sending one or more updates for a status of the entity offerings from the entity to the user, and wherein,
locating an entity comprises at least one of finding an entity in a specified area, finding an entity in a proximity to the user, and locating an entity based on at least one of a keyword search and an industry-specific search.

10. The method of claim 8, wherein the entity visit time is determined by a time for the user to travel from a first location to the specified location via one or more modes of transportation when one of the first table type and the second table type at the specified location is available to the user at a date and time selected by the user.

11. The method of claim 10, wherein the one or modes of transportation comprise walking and driving.

12. The method of claim 9, further comprising:
providing payment to the entity via a pre-paid account;
providing one or more comments from the user to the entity;
receiving an incentive at the user from the entity, wherein the incentive is at least based in part on information obtained from the geolocation device of the network connected device;
communicating with one or more additional users to one of split the payment between the user and the one or more additional users, and locate the entity, the specified location, and the entity visit time for each of the user and the one or more additional users to receive the one or more entity offerings, wherein the entity, specified location, and the entity visit time for each of the user and the one or more additional users comprise the same entity, specified location, and the entity visit time; and
providing at least a portion of the one or more entity offerings at the specified location at or near the entity visit time or an updated entity visit time, the updated entity visit time based at least in part on the one or more entity visit time updates,
wherein providing at least a portion of the one or more entity offerings at the specified location at or near the entity visit time or the updated entity visit time comprises providing the one or more entity offerings no more than three minutes after the entity visit time or the updated entity visit time.

13. The method of claim 12,
wherein the entity comprises a restaurant;
wherein the one or more entity offerings comprise menu options;
wherein each of the menu options display a cook time associated with the menu option;
wherein the entity visit time or the updated entity visit time comprises a dining reservation time;
wherein providing at least a portion of the one or more entity offerings at the specified location at or near the entity visit time or the updated entity visit time comprises providing at least one of the menu options at a Just In Time table at the dining reservation time, wherein the Just In Time table comprises the first table type;
wherein sending one or more updates for a status of the entity offerings from the entity to the user comprises sending at least one of a table reserved notification, a menu item on the table notification, a menu item being prepared notification, and a menu item ready in an identified time notification;
wherein providing one or more comments from the user to the entity comprises at least one of contacting an identified restaurant staff member or group, updating the one or more entity offerings, a table reserved rating, a menu item on the table rating, a menu item being prepared rating, a menu item ready in an identified time rating;
wherein providing payment to the entity via a pre-paid account comprises enabling a direct payment to the identified restaurant staff member or group and identifying a cost associated with each menu option associated with the user and the one or more additional users; and
wherein the request further comprises agreeing to leave the first table type after an agreed-to period of time requesting a first table type, wherein the agreed to period of time ends at or near the leave time, and wherein the first table type comprises a different table type than the second table type, and the second table type comprises a regular table type.

14. The method of claim 8,
wherein the entity visit time comprises an original entity visit time;
wherein sending one or more updates of the entity visit time from the user to the entity comprises providing the entity with a real-time update comprising a different entity visit time as compared to the original entity visit time, and wherein the different entity visit time comprises an updated entity visit time; and the method further comprising,
providing at least one of the entity and the user with information related to a current time, the entity offering ready time, and the entity visit time or the updated entity visit time before providing at least a portion of the one or more entity offerings at the specified location at or near the entity visit time or the updated entity visit time, and wherein the entity offering ready time is based at least in part on the approximate preparation time.

15. A non-transient computer-readable storage medium having instructions embodied thereon, the instructions being executable by one or more processors to perform a method for optimizing business-to-consumer wait times, the method comprising:
locating an entity via a network connected device, wherein the entity offers a plurality of sites, wherein at the plurality of sites comprise a first site having a first site time limit and a second site having a second site time limit, and wherein the entity offers decreased wait times to receive one or more entity offerings at a specified location on the first site as compared to wait times to receive the one or more entity offerings at the specified location on the second site;
receiving, from the entity, an approximate preparation time for at least a portion of the one or more entity offerings, the approximate preparation time based at least in part on a number of available sites of the first site type and a number of patrons at the entity, and wherein the approximate preparation time is displayed via the network connected device;
selecting at least one of the one or more entity offerings via the network connected device;
identifying an entity visit time for receiving the one or more entity offerings at the specified location on the first site type, wherein the entity visit time is at or after an entity offering ready time, and wherein the one or more entity offerings are ready at the entity offering ready time;
sending a request from a user to the entity, wherein the request comprises a request to receive the one or more entity offerings at the specified location on the first site type for the entity visit time, and wherein the request is sent via the network connected device;
receiving, at the network connected device, an acceptance from the entity to the user, wherein the acceptance comprises agreeing to provide the one or more entity offerings at the entity visit time; and
sending one or more updates of the entity visit time from the user to the entity, wherein the one or more entity visit time updates are sent via the network connected device, and comprise one of a late arrival and an early arrival, wherein the late arrival or the early arrival are based at least in part upon traffic information and information obtained from a geolocation device.

16. The computer-readable storage medium of claim 15, wherein the method further comprises:
sending one or more updates for a status of the entity offerings from the entity to the user, and wherein locating an entity comprises at least one of finding an entity in a specified area and finding an entity in a proximity to the user, and
wherein the method of locating an entity is based on at least one of a keyword search and an industry-specific search.

17. The computer-readable storage medium of claim 15, wherein the entity visit time is determined by a time for the user to travel from a first location to the specified location via one or more modes of transportation when one of the first site and the second site at the specified location are available to the user at a date and time selected by the user.

18. The computer-readable storage medium of claim 17, wherein the one or modes of transportation comprise walking and driving.

19. The computer-readable storage medium of claim 16, wherein the method further comprises:
providing payment to the entity via a pre-paid account;
providing one or more comments from the user to the entity;
receiving an incentive at the user from the entity, wherein the incentive is at least based in part on information obtained from the geolocation device of the network connected device;
communicating with one or more additional users to one of split the payment between the user and the one or more additional users, and locate the entity, the specified location, and the entity visit time for each of the user and the one or more additional users to receive the one or more entity offerings, wherein the entity, specified location, and the entity visit time for each of the user and the one or more additional users comprise the same entity, specified location, and the entity visit time; and
providing at least a portion of the one or more entity offerings at the specified location at or near the entity visit time or an updated entity visit time, the updated entity visit time based at least in part on the one or more entity visit time updates,
wherein providing at least a portion of the one or more entity offerings at the specified location at or near the entity visit time or the updated entity visit time comprises providing the one or more entity offerings no more than three minutes after the entity visit time or the updated entity visit time.

20. The computer-readable storage medium of claim 19, wherein the entity comprises a business;
wherein the one or more entity offerings comprise menu options;
wherein each of the menu options display a preparation time associated with the menu option;
wherein the entity visit time or the updated entity visit time comprises a reservation time;
wherein providing at least a portion of the one or more entity offerings at the specified location at or near the entity visit time or the updated entity visit time comprises providing at least one of the menu options at a Just In Time site at the reservation time, wherein the Just In Time site comprises the first site time limit;
wherein sending one or more updates for a status of the entity offerings from the entity to the user comprises sending at least one of a site reserved notification, a menu item on the site notification, a menu item being prepared notification, and a menu item ready in an identified time notification;
wherein providing one or more comments from the user to the entity comprises at least one of contacting an identified entity staff member or group, updating the one or more entity offerings, a site reserved rating, a menu item on the site rating, a menu item being prepared rating, a menu item ready in an identified time rating;
wherein providing payment to the entity via a pre-paid account comprises enabling a direct payment to the identified entity staff member or group and identifying a cost associated with each menu option associated with the user and the one or more additional users; and
wherein the request further comprises agreeing to leave the first site after the first site time limit, and wherein the first site comprises a different time limit than the second site time limit, and the second site comprises a regular time limit.
